(19) United States
(12) Patent Application Publication
(10) Pub. No.: US 2019/0190703 A1
(43) Pub. Date: Jun. 20, 2019

(54) SYSTEMS AND METHODS FOR USING AN OUT-OF-BAND SECURITY CHANNEL FOR ENHANCING SECURE INTERACTIONS WITH AUTOMOTIVE ELECTRONIC CONTROL UNITS

(71) Applicant: Auton, Inc., Snoqualmie, WA (US)

(72) Inventor: Panayotis Lekkas, Worcester, MA (US)

(21) Appl. No.: 15/845,859

(22) Filed: Dec. 18, 2017

(51) Int. Cl. H04L 9/08; H04W 4/46; H04L 29/08

(52) U.S. Cl. CPC H04L 9/0822; H04L 2209/84; H04L 67/12; H04W 4/46

(57) ABSTRACT

A method is provided for securely communicating protected data to a vehicle of a vehicle fleet. The method includes encrypting the protected data, which is configured to update the vehicle's automotive control systems, with an encryption key. The encrypted protected data is transmitted to the vehicle over a selected network of one or more data networks based on bandwidth, cost, and geographic access to the vehicle. The data networks provide narrower geographic access to the vehicle than a satellite constellation network. The satellite constellation network operates as an out-of-band side-channel to provide security enhancement to the data networks. The encryption key is also encrypted using a first key of a key-encryption key (KEK) pair and can be decrypted by a second key of the KEK pair which is in the vehicle's possession. The encrypted encryption key is transmitted directly to the vehicle over the out-of-band satellite constellation network.

### TECHNICAL FIELD

The present application is generally related to automotive electronics, and more particularly to securely delivering data to electronic control units.

### BACKGROUND OF THE INVENTION

Modern vehicles contain a multitude of microprocessors or electronic control units (ECU). Each ECU may be supported by memory and effectively operates as an autonomous computer responsible for controlling automotive systems. For example, ECUs may control critical vehicle operations such as fuel injection, emissions, throttle, transmission, exterior lighting, braking, and traction systems. ECUs may also control safety or comfort systems such as supplemental restraint systems (e.g., air bags, seat belts, or other safety devices), climate control, cruise control, navigation, audio, video, and blind spot monitoring. As with any other electronic system, the ECUs controlling these automotive systems may require data (e.g., software, firmware, or other control instructions) updates over time. This is particularly important considering the dangerous potential of malfunctioning vehicles and the amount of time a particular vehicle may remain in service.

Vehicle manufacturers may provide data updates as a part of a recall, to improve existing features, to provide expanded functionality, or to prolong the service life of the vehicle. Due to the potential risk of injury or fatality to drivers or pedestrians that could be caused by unauthorized data modifications, vehicle manufacturers desire a way to securely deliver authorized automotive data updates to their vehicle fleet.

Presently, a vehicle owner can securely obtain authorized automotive data updates by taking the vehicle to a dealership or mechanic affiliated with the vehicle's manufacturer. However, it may be months or even years after the vehicle manufacturer has released a particular data update before the owner takes the vehicle to the dealership or mechanic. The vehicle owner may not even know that new data updates for the vehicle's automotive systems exist. Even if the owner regularly takes the vehicle to the dealership or mechanic for routine maintenance, there may be a gap in time from when the vehicle manufacturer released the data updates and when the vehicle next visits the dealership or mechanic.

Seeking to solve this inefficient method for distributing data updates by connecting a manufacturer's vehicle fleet to short- or long-range networks may introduce additional cybersecurity problems. A malicious actor may use equipment to monitor the manufacturer's data delivery network and, given sufficient time and effort, penetrate the security protocols protecting these networks and compromise the safety and operations of the manufacturer's vehicle fleet.

### BRIEF SUMMARY OF THE INVENTION

The present invention is directed to methods, apparatuses, and computer-readable storage media for using cryptographic communications via an out-of-band, side-channel security network to provide security enhancement to in-band vehicle data communications via one or more data networks. Embodiments of the present invention enable secure communication of protected data to a vehicle fleet which substantially eliminates or reduces disadvantages and problems with previous systems and methods.

Internet protocol (IP) network infrastructures have been widely adopted across the world and the proliferation of IP networks has produced a global patchwork of private and commercial data networks. For example, IP network infrastructures are the backbone of wired and wireless local area networks, wired and wireless local area networks, wired and wireless wide area networks, cellular broadband networks, and the Internet in general. Additionally, radio communications (e.g., ultra-high frequency ATSC 3.0 television broadcasting) and satellite networks (e.g., geostationary satellites and low Earth orbit (LEO) satellites) provide an additional means for remote data delivery. The geographic coverage provided by each of these data networks may depend on the amount and location of relay and transmission sources, signal strength, broadcast spectrum licensing and regulatory limitations, topographic interference, the curvature of the Earth, etc. An individual's access to one or more of these data networks may also depend on whether the individual has a subscription with the data network and/or the proper equipment to communicate with the data network. A network-connected vehicle may often be traveling through and between data networks, which may result in degraded or loss of network accessibility.

In accordance with embodiments of the present invention, cryptographic side-channel communications via an out-of-band security network (e.g., a network provided by an LEO satellite constellation) are used to provide security enhancement with respect to one or more data networks. This may be accomplished, for example, by delivering encrypted data (e.g., automotive software, automotive firmware updates, digital media content) via one or more data networks while also delivering encryption parameters through an unrelated out-of-band network. Even if a malicious actor were to intercept communications across the one or more data networks, the actor may have difficulty penetrating the security protocols if the encryption parameters are separately delivered via the security network. For example, the malicious actor may not know that the security network exists or may lack the appropriate equipment to intercept the communications via the unrelated, out-of-band security network.

Security may further be enhanced according to embodiments of the invention by introducing an additional tier of encryption. For example, the encryption parameters that are delivered via the security network may also be encrypted, such as using an encryption protocol different than that implemented with respect to the one or more data networks. In operation according to embodiments of the invention, the vehicle manufacturer, or a designated proxy, and the vehicle may each possess half of a key-encryption key (KEK) pair that may be used to encrypt and decrypt the encryption parameters. Even if a malicious actor were to intercept both the out-of-band security network communications and the in-band data network communications, the actor may have difficulty obtaining the encryption parameters needed to decrypt the protected data. For example, due to the encryption-setup handshake between the respective vehicle and manufacturer during the generation of the keys of the KEK pair, it may be exceedingly difficult or impractical for anyone other than the vehicle and the manufacturer, or a designated proxy, to decrypt the encryption parameters and, in turn, decrypt the protected data.

In accordance with embodiments of the present invention, a security network that is unrelated to any of the various data networks and that provides broader, near-ubiquitous coverage as compared to the various data networks is used to enhance the performance and security of such data networks when used for communication of protected data to vehicles. The unrelated nature of the security network to the data networks may involve dedicated communications equipment but also facilitates accessibility to the security network even if the vehicle does not have a subscription with or equipment for one or more of the data networks providing data communication for any particular geographic area. The equipment used to communicate with the security network may include different antenna configurations and/or additional modulators, demodulators, decoders, encoders, etc. that are unique to the security network and which are not needed for communication with the data networks. Due to its broader coverage, the security network may provide out-of-band communications with the traveling vehicle and the vehicle can communicate with the security network even when communication or reception with any or all of the data networks is unavailable. This more reliable access to the vehicle facilitates the security network of embodiments to serve as an anchor for the data networks. For example, the security network may use information provided by the traveling vehicle to determine which particular data network may be optimal for delivering data content to the vehicle. The security network may also take into account the traveling vehicle's trajectory through a data network coverage zone and predict the next data network coverage zone that the vehicle may be entering. This may enable the vehicle to proactively switch to a next data network coverage zone, whether contiguous and uninterrupted or separated and resulting in a gap in content delivery, in order to provide desired data delivery.

In accordance with one aspect of the present invention, systems, methods, and computer-readable storage media are provided for encrypting, with an encryption key, protected data for communication to a select vehicle of a vehicle fleet. The protected data of embodiments is configured to update one or more automotive control systems of the select vehicle. The encryption key is configured to encrypt the protected data and decrypt the encrypted protected data according to embodiments. The systems, methods, and computer-readable storage media may further comprise transmitting the encrypted protected data to the select vehicle via a selected network of one or more data networks. In accordance with embodiments of the invention, the one or more data networks comprise at least one internet protocol network, and the selected network is chosen based on bandwidth (e.g., transfer speed, channel capacity, channel throughput, etc.), costs (e.g., data transmission charges, rerouting processing, quality of service, etc.), and geographic access to the select vehicle. Each of the one or more data networks may, for example, provide narrower geographic access to the select vehicle than a security network. Also, the one or more data networks of embodiments exclude the security network. In accordance with embodiments of the invention, the security network comprises a network provided by an LEO satellite constellation and is configured as an out-of-band side-channel to provide security enhancement to the one or more data networks. Further, the select vehicle thus preferably comprises two or more wireless communication interfaces. A first interface of the two or more wireless communication interfaces may, for example, be configured to communicate with the security network and a second interface of the two or more wireless communication interfaces may be configured to communicate with the one or more data networks. The systems, methods, and computer-readable storage media may further comprise encrypting the encryption key using a first key of a KEK pair associated with the select vehicle. The encrypted encryption key of embodiments is configured to be decrypted by a second key of the KEK pair possessed by the select vehicle. The systems and methods may also comprise transmitting the encrypted encryption key directly to the select vehicle via the security network.

More specifically, in an embodiment of the present invention, the first key of the KEK pair comprises a public encryption key unrestricted to the processor and the select vehicle of the vehicle fleet. The second key of the KEK pair comprises a private encryption key exclusive to the processor and the vehicle. In another embodiment, the first key of the KEK pair and second key of the KEK pair are symmetric keys generated independently by the processor and the select vehicle of the vehicle fleet based on pre-established seed and algorithm-choice parameters. In another embodiment, the method further comprises transmitting the encrypted protected data to a plurality of vehicles of the vehicle fleet via one or more data networks and transmitting the encrypted encryption key directly to the plurality of vehicles via the security network. The systems, methods, and computer-readable storage media of embodiments further comprise generating the encryption key based on a dataset of a plurality of datasets and on a pre-determined interval. Each of the plurality of datasets comprise a different amount of information and correspond to a control system of the one or more automotive control systems of the select vehicle. In accordance with embodiments of the invention, the pre-determined interval may be greater when the dataset comprises more information and lower when the dataset comprises less information.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 illustrates a block diagram of an embodiment of a system for secure communication of protected data to a select vehicle of a vehicle fleet using cryptographic communications via an out-of-band side-channel;

FIG. 2 illustrates a block diagram of an embodiment of an apparatus for secure communication of protected data to a select vehicle of a vehicle fleet; and

FIG. 3 illustrates a flow diagram of an embodiment of a method for cryptographic use of an out-of-band side-channel to enhance communication security via one or more in-band data networks.

### DETAILED DESCRIPTION OF THE INVENTION

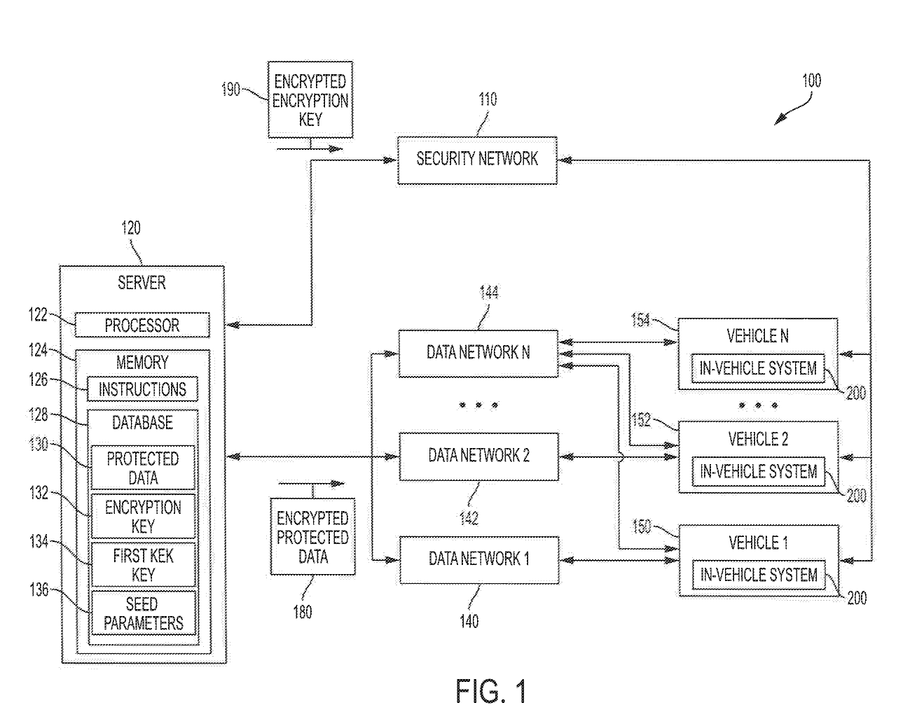

Referring to FIG. 1, an embodiment of a system for secure communication of protected data to a select vehicle of a vehicle fleet is shown as system 100. As shown in FIG. 1, system 100 includes security network 110, server 120, one or more data networks 140, 142, and 144, and vehicles 150, 152, and 154. Server 120 may be communicatively coupled to vehicles 150, 152, and 154, comprising a portion of a vehicle fleet, via one or more data networks 140, 142, and 144 and via security network 110.

In an embodiment, one or more data networks 140, 142, and 144 may include terrestrial networks such as wired networks, wireless networks, local area networks (LANs), wireless LANs (WLANs), wide area networks (WANs), metropolitan networks (MANs), Wi-Fi networks, Worldwide interoperability for Microwave Access (WiMAX) networks, public networks (e.g., the Internet), private networks (e.g., a vehicle owner's home wireless or wired network), cellular broadband networks (e.g. LTE, CDMA200, EDGE, etc.), multi-network mobile virtual network operator (MVNO) networks, ultra-high frequency (UHF) Advanced Television Systems Committee (ATSC) networks, radio frequency (RF) networks, other network infrastructures and topologies, or combinations thereof. In some embodiments, one or more data networks 140, 142, and 144 may additionally or alternatively include geostationary (GEO) satellite networks, such as Ku band satellite networks, Ka band satellite networks, or combinations thereof. Data networks of one or more data networks 140, 142, and 144 may operate on different frequency bands (licensed and/or unlicensed) of the radio frequency spectrum, in different geographic coverage areas (overlapping and/or non-overlapping), and with different networking protocols (e.g., TCP/IP, Space Communications Protocol Specifications (SCPS), IEEE 802.15.4, Wi-Fi, Bluetooth, etc.). Additionally or alternatively, data networks of one or more data networks 140, 142, and 144 of embodiments may provide different bandwidth (e.g., transfer speed, channel capacity, channel throughput, etc.), costs (e.g., data transmission charges, rerouting processing, quality of service, etc.), and geographic access to the vehicle fleet. It should be appreciated that, although shown as comprising three data networks, one or more data networks 140, 142, and 144 of embodiments of the present invention may be comprised of more than or less than three data networks. Irrespective of the particular number of data networks comprising one or more data networks 140, 142, and 144, a data network of one or more data networks 140, 142, and 144 of embodiments herein facilitates data communication (e.g., communication of protected data, such as encrypted protected data 180) between any or all vehicles of vehicles 150, 152, and 154 and server 120.

In addition to, and independent of, the data networks of data networks 140, 142, and 144, security network 110 may be used for security communication between server 120 and any or all of vehicles 150, 152, and 154, such as for enhanced security with respect to the protected data communications via one or more data networks 140, 142, and 144. That is, security network 110 of embodiments comprises an out-of-band network with respect to data networks 140, 142, 144. Security network 110 preferably provides broader geographic coverage than any individual data network of data network 140, 142, and 144. In some embodiments, security network 110 may provide near-ubiquitous access to the vehicle fleet. Security network 110 of embodiments may, for example, comprise a satellite constellation network, such as an LEO Ku-band satellite constellation network, an LEO Ka-band satellite constellation network, an LEO L-band satellite constellation network, a Walker Delta Pattern satellite constellation network, a Walker Star satellite constellation network, a V-band low-Earth orbit (VLEO) satellite constellation network, other satellite constellation infrastructures and topologies, or combinations thereof. Although shown as comprising a single security network, it should be appreciated that security network 110 of embodiments of the present invention may be comprised of a plurality of security networks. Irrespective of the particular number of networks comprising the security network, security network 110 of embodiments herein facilitates communication of security parameters (e.g., encrypted encryption key 190, seed parameters 136, etc.) between server 120 and vehicles of vehicles 150, 152, and 154.

Referring to the server side of FIG. 1, server 120 of embodiments includes processor 122 and memory 124. Processor 122 may include a single processor, or multiple processors, each of which may include a single processing core, multiple processing cores, or combinations thereof. In operation according to embodiments, processor 122 may be configured to transmit encrypted protected data 180, via one or more data networks 140, 142, and 144, and encrypted encryption key 190, via security network 110, to one or more vehicles of the vehicle fleet (e.g., a selected one of vehicles 150, 152, and 154; a plurality of vehicles 150, 152, and 154; etc.), as described in more detail below. Memory 124 of embodiments may include random access memory (RAM) devices, read-only memory (ROM devices), flash memory devices, hard disk drives (HDD), solid state drives (SSDs), other memory devices configured to store information in a persistent or non-persistent state, or combinations thereof. In operation according to embodiments, memory 124 may store instructions 126 that, when executed by processor 122, cause processor 122 to perform the operations for transmitting encrypted protected data 180, via one or more data networks 140, 142, and 144, and encrypted encryption key 190, via security network 110, to one or more vehicles of the vehicle fleet. In some embodiments, the functionality of server 120 may be implemented on a single server. In alternative embodiments, the functionality of server 120 may be implemented across multiple servers.

In an embodiment, memory 124 may store database 128 containing information that may be used to support the operations of server 120. Database 128 of embodiments, or a portion thereof, may be stored at a memory external to server 120, such as a network attached storage device, a remote database server, other devices accessible to server 120, or combinations thereof. In accordance with embodiments, exemplary information stored at database 128 and used to support the operations of server 120 may include protected data 130, encryption key 132, first key 134 of a KEK pair, and/or seed parameters 136.

In some embodiments, protected data 130 may be stored in database 128. In additional embodiments, protected data 130 may be first received from a content provider (e.g., the owner or source of the protected data). For example, the content provider may include a manufacturer of the vehicle fleet comprising vehicles 150, 152, and 154, an owner of multimedia content (e.g., video, audio, radio, etc.), and/or an entity with control of server 120. Protected data 130 of embodiments may include data (e.g., software, firmware, other control instructions, etc.) updates for automotive ECUs, or any other form of data content that requires protection to prevent unauthorized use or modification, or combinations thereof. Although embodiments and examples described below involve delivering firmware updates for automotive ECUs to a select vehicle, such discussions are for purposes of illustration and it should be appreciated that the concepts described herein may be used to likewise deliver other forms of protected data to a select vehicle, a plurality of vehicles, or even all vehicles in a fleet.

In an embodiment, encryption key 132 may be used with a cryptographic algorithm such as AES (in any one of its multiple cryptographic modes, such as CBC, CFB, ECB, GCM, etc.), 3DES, RSA, ECC, Elliptic-curve Diffie-Hellman (ECDH), Elliptic-curve Integrated Encryption Scheme (ECIES), or other types of cryptographic encryption algorithms. In some embodiments, the block size (e.g., a fixed-length groups of bits) of the underlying encryption process and the key size (e.g., number of bits used by the cryptographic algorithm) of encryption key 132 may vary depending on the type of protected data to be encrypted. In operation according to embodiments, a varying matrix of block size and key size may be used for the underlying encryption process, which provides additional dimensions of encryption and results in an encryption process that is less susceptible to brute-force attack. In additional embodiments, hash functions (e.g., a mathematical algorithm that maps data of arbitrary size to a bit string of a fixed size) may also be used in the varying block size and key size matrix to provide additional security. Although shown as comprising a single encryption key, it should be appreciated that encryption key 132 of embodiments of the present invention may be comprised of a plurality of encryption keys. Irrespective of the particular number of encryption keys stored in database 128, encryption key 132 of embodiments herein facilitates encrypting protected data 130 as encrypted protected data 180.

In some embodiments, first key 134 of a key-encryption key (KEK) pair may be stored in database 128. In some embodiments, a unique first key for each vehicle (e.g., a selected one of vehicles 150, 152, and 154) of the vehicle fleet may be stored in database 128. For example, database 128 of server 120 may store a first key for vehicle 150 and a different first key for vehicle 152. In some embodiments, first key 134 may be an asymmetric public key associated with vehicle 150 generated using RSA, ECC, or any other type of asymmetric cryptography protocols. A public key of embodiments associated with vehicle 150 may be possessed by server 120, vehicle 150, or any other party. In alternative embodiments, first key 134 may be a symmetric key derived from a common secret generated from ECDH, ECIES, or any other form of symmetric cryptographic protocol. It should be appreciated that, although shown as comprising a single first key of a KEK pair, first key 134 of embodiments of the present invention may be comprised of a plurality first keys associated with the vehicles (e.g., a selected one of vehicles 150, 152, and 154) of the vehicle fleet. Irrespective of the particular number of first keys stored in database 128, first key 134 of embodiments herein facilitates encrypting encryption key 132 as encrypted encryption key 190.

In some embodiments, seed parameters 136 may be stored in database 128. In operation according to embodiments, seed parameters 136 may be used by processor 122 to generate first key 134 associated with vehicle 150. Seed parameters 136 may, for example, be a shared secret possessed by server 120 and vehicle 150 for establishing a common algorithmic mode of cryptographic operation between the server 120 and vehicle 150 to facilitate generation of the symmetric keys of a KEK pair. In alternative embodiments, seed parameters 136 may be an exclusive secret possessed only by server 120. For example, processor 122 of server 120 may use seed parameters 136 to generate first key 134 (e.g., a public key associated with vehicle 150) and second key 226 (e.g., a private key associated with vehicle 150) and transmit second key 226 to vehicle 150 via security network 110. In additional embodiments, server 120 may use seed parameters 136 to generate a private key and a public key of an asymmetric KEK pair associated with server 120 to facilitate communications from vehicle 150 to server 120. Although shown as comprising a single instance of seed parameters, it should be appreciated that seed parameters 136 of embodiments of the present invention may be comprised of a plurality of seed parameters. Irrespective of the particular number of seed parameters stored in database 128, seed parameters 136 of embodiments herein facilitate the generation of first and/or second keys of KEK pairs used for secure communications across security network 110 between server 120 and a vehicle of vehicles 150, 152, and 154.

Turning to the vehicles side of FIG. 1, a vehicle fleet is shown as including a first vehicle 150, a second vehicle 152, and an Nth vehicle 154. In operation according to embodiments, one or more vehicles of the vehicle fleet (e.g., a selected one of vehicles 150, 152, and 154) may be configured to receive encrypted protected data 180 via one or more data networks 140, 142, and 144 and encrypted encryption key 190 via security network 110. It is noted that, in FIG. 1, server 120 is shown as being communicatively coupled to three vehicles for purposes of illustration, rather than by way of limitation, and, in other embodiments of system 100, server 120 may be communicatively coupled to more than three or less than three vehicles. Although embodiments described in the context of FIGS. 1, 2, and 3 may refer to vehicle 150, it should be appreciated that the concepts herein may likewise apply to a plurality of vehicles or even all vehicles in a fleet. In some embodiments, vehicles 150, 152, and 154 may include electric vehicles, diesel combustion vehicles, gasoline combustion vehicles, autonomous vehicles, or other forms of personal and mass transportation. In additional embodiments, vehicles 150, 152, and 154 may include trains, boats, ships, submarines (when operating on the sea surface), planes, or other forms of non-automotive (manned or autonomous) transportation. Although embodiments and examples described herein involve modes of transportation, it should be appreciated that the concepts described herein may be used to likewise deliver protected data to other autonomous devices, such as sensor buoys, autonomous probes, autonomous drones, etc.

Vehicles 150, 152, and 154 of embodiments may include a plurality of automotive electronics and/or automotive embedded systems, collectively referred to herein as electronic control units (ECU). ECUs of embodiments may be classified according to different automotive domains such as engine systems, transmission systems, chassis electronics, active safety systems, driver assistance systems, passenger comfort systems, and infotainment systems. For example, engine system ECUs may include fuel injection controls, emission controls, throttle control, ignition controls, and/or any other systems that control engine functionality. Transmission system ECUs may control how engine gears are shifted during operation of the vehicle and may vary in amount depending on whether a vehicle is equipped with a manual clutch, a semi-auto clutch, a fully automatic clutch, a continuously variable transmission, or other type of electronic transmission system. Chassis system ECUs may monitor and actively control various driving parameters and may include the anti-lock braking system (ABS), traction control system (TCS), electronic stability program (ESP), and/or any other vehicle stability systems. Active safety system ECUs may act when a vehicle collision is in progress or to prevent a vehicle collision and may include air bag controls, seat belt controls, hill descent or climb controls, and emergency brake assist controls, and/or any other safety systems. Driver assistance ECUs may include lane assist systems, blind spot detection systems, parking assist systems, adaptive cruise control systems, tire pressure monitoring systems, and/or any other driver assistance systems. Passenger comfort ECUs may include automatic climate control systems, electronic seat adjustment systems, seat heating systems, automatic wiper systems, and/or any other systems that enhance passenger comfort. Infotainment system ECUs may include navigation systems, onboard systems (e.g., audio systems, video systems, web browsing systems, etc.), mobile device interface systems (e.g., USB, Bluetooth, etc.), in-car internet systems, in-car Wi-Fi systems, and/or any other information and entertainment systems. Autonomous vehicles may include even more ECUs than human-operated vehicles.

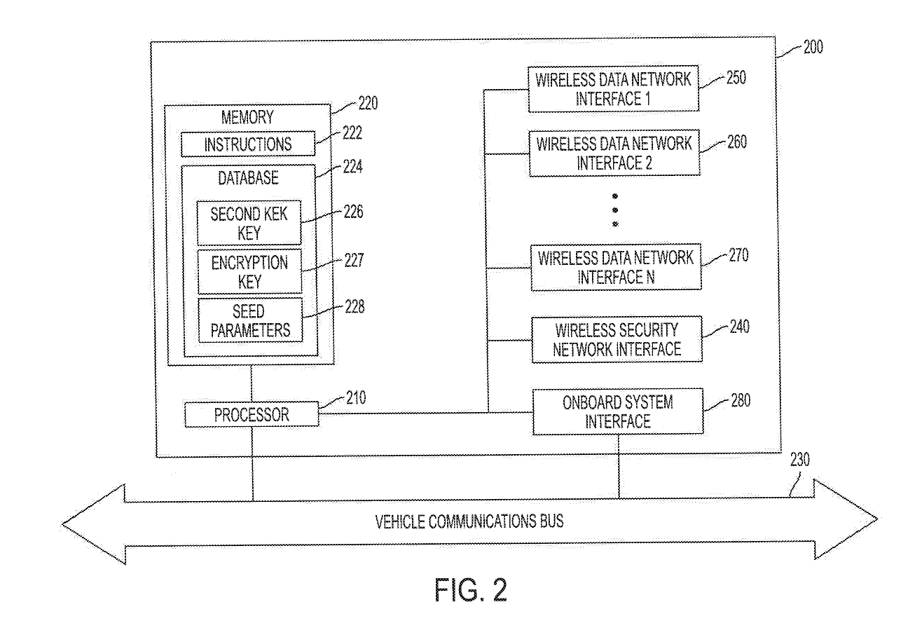

In an embodiment, vehicles 150, 152, and 154 may each contain an in-vehicle system (IVS) (e.g., in-vehicle system 200), as described in connection with the operations of system 100 with reference to FIGS. 1 and 2. IVS 200 of embodiments is an ECU and may be embedded in vehicle 150's roof, side pillars, cabin, front hood or nose section, and/or rear or tail section. Referring to FIG. 2, an embodiment of an apparatus for IVS 200 is shown. As shown in FIG. 2, IVS 200 of embodiments includes processor 210, memory 220, wireless security network interface 240, one or more wireless data network interfaces 250, 260, and 270, and onboard system interface 280. Processor 210 and onboard system interface 280 may be communicatively coupled to vehicle 150's other ECUs via vehicle communications bus 230. Processor 210 also may be communicatively coupled to memory 220, wireless security network interface 240, one or more wireless data network interfaces 250, 260, and 270, and onboard system interface 280 via vehicle communications bus 230. In some embodiments, processor 210, memory 220, wireless security network interface 240, one or more wireless data network interfaces 250, 260, and 270, and onboard system interface 280 of IVS 200 may be organized in an array. In alternative embodiments, processor 210, memory 220, wireless security network interface 240, one or more wireless data network interfaces 250, 260, and 270, and onboard system interface 280 of IVS 200 may be distributed throughout vehicle 150. For example, processor 210, onboard system interface 280, and memory 220 may be embedded inside vehicle 150's cabin; wireless security network interface 240 and one or more wireless data network interfaces 250, 260, and 270 may be embedded in vehicle 150's roof; and vehicle communications bus 230 may be embedded throughout vehicle 150's roof, side pillars, and cabin. Although one or more wireless data network interfaces 250, 260, and 270 have been described herein as components of IVS, in some embodiments one or more wireless data network interfaces 250, 260, and 270 may be separate vehicle ECUs that are communicatively coupled to IVS 200 via vehicle communications bus 230 and onboard system interface 280. Furthermore, while embodiments of IVS 200 have been described herein with reference to a select vehicle, it should be appreciated that the concepts herein may be likewise implemented on each vehicle of the vehicle fleet.

In an embodiment, vehicle communications bus 230 may be an internal communications network that interconnects components inside a vehicle that may comprise, for example, Controller Area Network (CAN), Local Interconnect Network (LIN), Multifunction Vehicle Bus, Domestic Digital Bus (D2B), DC-BUS, Media Oriented Systems Transport (MOST), Vehicle Area Network (VAN), other internal vehicle communications network topologies and protocols, or combinations thereof. Vehicle communications bus 230 of embodiments connects IVS 200 with vehicle 150's other ECUs, such as vehicle 150's engine system ECUs, transmission system ECUs, chassis electronic ECUs, active safety system ECUs, driver assistance system ECUs, passenger comfort system ECUs, and infotainment system ECUs.

In an embodiment, wireless security network interface 240 may include an antenna, a modulator, a demodulator, a forward error correction (FEC) encoder, a differential encoder, a scrambler, a descrambler, a multiplexer, a demultiplexer, and/or other satellite modem components. In some embodiments, each vehicle (e.g., a selected one of vehicles 150, 152, and 154) of the vehicle fleet may be communicatively coupled to security network 110 via wireless security network interface 240 of their respective IVS 200. Although shown as comprising a single wireless security network interface, it should be appreciated that wireless security network interface 240 of embodiments of the present invention may be comprised of a plurality of wireless security network interfaces. Irrespective of the particular number of wireless security network interfaces, wireless security network interface 240 of embodiments herein facilitates communication of security parameters (e.g., encrypted encryption key 190, seed parameters 136, etc.) between vehicles of vehicles 150, 152, and 154 and security network 110.

In an embodiment, one or more wireless data network interfaces 250, 260, and 270 may include Wi-Fi transceivers, cellular network transceivers, RF transceivers, satellite modems, other types of wireless communication interfaces, or combinations thereof. One or more wireless data network interfaces 250, 260, and 270 of embodiments facilitate access to one or more data networks 140, 142, and 144 by vehicle 150. It is noted that, in FIG. 2, IVS 200 is shown with three wireless data network interfaces for purposes of illustration, rather than by way of limitation, and in other embodiments of system 100, IVS 200 may contain more than three or less than three wireless data network interfaces.

In some embodiment, IVS 200 may be communicatively coupled to a GPS interface via onboard system interface 280. The UPS interface may include a multi-channel satellite antenna, a processor, and a stable clock. IVS 200 of embodiments may be communicatively coupled to a global positioning satellite system via the UPS interface and may provide time information and vehicle 150's geolocation information obtained via the GPS interface to processor 210. In some embodiments, the time information and vehicle 150's geolocation may be transmitted to server 120 to facilitate server 120 performing the operations of choosing a selected network of one or more data networks 140, 142, and 144 to transmit encrypted protected data 180 to vehicle 150 and monitoring load and congestion (e.g., amount of network traffic), bandwidth (e.g., transfer speed, channel capacity, channel throughput, etc.), quality of service (e.g., packet loss, bit rate, throughput, transmission delay, availability, jitter, etc.) across one or more data networks 140, 142, and 144. Although the GPS interface has been described above as a separate ECU with respect to IVS 200, it should be appreciated that in some embodiments the GPS interface may be incorporated into IVS 200.

In operation according to embodiments, processor 210 may be configured to receive encrypted protected data 180 via one or more data networks 140, 142, and 144 and encrypted encryption key 190 via security network 110 and decrypt encrypted encryption key 190 and encrypted protected data 180, as described in connection with the operations of system 100 with reference to FIGS. 1 and 2. Memory 220 may store instructions 222 that, when executed by processor 210, cause processor 210 to perform the operations for decrypting encrypted encryption key 190 and encrypted protected data 180. In additional embodiments, processor 210 may be configured to monitor load and congestion (e.g., amount of network traffic), bandwidth (e.g., transfer speed, channel capacity, channel throughput, etc.), quality of service (e.g., packet loss, bit rate, throughput, transmission delay, availability, jitter, etc.) across data networks of one or more data networks 140, 142, and 144 that vehicle 150 may have access to; choose a preferred data network of one or more data networks 140, 142, and 144 for server 120 to transmit encrypted protected data 180 across; and transmit the identified choice of preferred network to server 120 via one or more data networks 140, 142, and 144. Processor 210 embodiment may also use onboard system interface 280 (e.g., a separate hardware component or a software implemented on processor 210) to communicate with other onboard vehicle ECUs via vehicle communications bus 230.

In some embodiments, memory 220 may store database 224 containing information that may be used to support the operations of IVS 200. Exemplary information that may be stored at database 224 and used to support the operations of IVS 200 may include second key 226, seed parameters 228, and encryption key 227. Although embodiments below describe the operations of second key 226, seed parameters 228, and encryption key 227 with respect to a select vehicle, it should be appreciated that the concepts herein may likewise apply to a plurality of vehicles or even all vehicles in a fleet.

Second key 226 of embodiments corresponds to first key 134 stored in database 128 of server 120. In operation according to embodiments, second key 226 of embodiments may be used by vehicle 150's processor 210 to decrypt encrypted encryption key 190 received from server 120 via security network 110. In some embodiments, second key 226 may be an asymmetric private key associated, for example, with vehicle 150 and may be possessed only by server 120 and vehicle 150. In alternative embodiments, second key 226 may be a symmetric key. In some embodiments, second key 226 may be generated by processor 210.

Encryption key 227 of embodiments may correspond to encryption key 132 stored in memory 124 of server 120. In some embodiments, a plurality of encryption keys may be stored in database 224, each corresponding to a different type of encrypted protected data. For example, data (e.g., software, firmware, or other control instructions) updates provided by vehicle 150's manufacturer for vehicle 150's engine system ECUs may use a first encryption key, while data updates for vehicle 150's infotainment system ECUs from the same manufacturer may use a second encryption key. Irrespective of the particular number of encryption keys stored in database 224, encryption key 227 of embodiments herein facilitates decrypting encrypted protected data 180 into protected data 130.

In an embodiment, seed parameters 228 may be stored in database 224 of IVS 200 for each vehicle (e.g., a select vehicle of vehicles 150, 152, and 154) of the vehicle fleet. In operation according to embodiments, seed parameters 228 may be used by vehicle 150's processor 210 to generate second key 226. In some embodiments, seed parameters 228 may be a shared secret possessed by both server 120 and vehicle 150. For example, seed parameters 228 may contain the same information as seed parameters 136 stored in database 128 of server 120. In alternative embodiments, seed parameters 228 may be an exclusive secret possessed only by vehicle 150. In such embodiments, processor 210 of vehicle 150 may use seed parameters 228 to generate first key 134 (e.g., a public key associated with vehicle 150) and second key 226 (e.g., a private key associated with vehicle 150) and transmit first key 134 to server 120 via security network 110.

During operation of system 100, server 120 or instructions 126 executing on processor 122 may retrieve protected data 130 from database 128 to send to vehicle 150. In some embodiments, server 120 may have initially received protected data 130 from a content provider with instructions to deliver protected data 130 to vehicle 150. In additional embodiments, the content provider may be a manufacturer of the vehicle fleet (e.g., vehicles 150, 152, and 154). In alternative embodiments, the content provider may be a multimedia copyright holder or its designated proxy. In some embodiments, protected data 130 may be firmware, software, or other control instruction updates for an automotive ECU. For example, protected data 130 may be a firmware update for vehicle 150's engine control ECU that provides for smoother power delivery. In another example, protected data 130 may be control instructions for an autonomous shipping tanker that controls the tanker's navigation and operations. In alternative embodiments, server 120 may have retrieved protected data 130 in response to a request for protected data 130 received from vehicle 150. Requests for protected data 130 from vehicle 150 of embodiments may be received by server 120 via one or more data networks 140, 142, and 144. In alternative embodiments, requests for protected data 130 from vehicle 150 may be received by server 120 via security network 110.

In response to retrieving protected data 130, server 120 or instructions 126 executing on processor 122 may retrieve encryption key 132 from database 128. In some embodiments, server 120 may have generated encryption key 132 to encrypt protected data 130. In operation according to embodiments, longer symmetric keys may require exponentially more effort to break, and as such, longer keys may be preferred for data updates involving critical automotive systems. For example, if protected data 130 contains data updates for vehicle 140's throttle control ECU, the key size of encryption key 132 may be 256 bits and the block size may be modified accordingly. In an additional example, if protected data 130 contains data updates for vehicle 140's navigation ECU, the key size of encryption key 132 may be 128 bits and the block size may be modified accordingly. In additional embodiments, protected data 130 for similarly classified ECUs may utilize encryption keys generated using the same amount of data. For example, encryption key 132 for protect data 130 containing updates for vehicle 150's engine systems (e.g., throttle ECU, emissions ECU, etc.) may have a key size of 256 bits, encryption key 132 for protect data 130 containing updates for vehicle 150's chassis systems (e.g., ABS ECUs, TCS ECUs, etc.) may have a key size of 192 bits, and encryption key 132 for protect data 130 containing updates for vehicle 150's passenger comfort systems (e.g., climate control ECUs, seat heating ECUs, etc.) may have a key size of 128 bits. In alternative embodiments, encryption key 132 may have been generated during a previous security session and stored in database 128 to be reused for subsequent security sessions. For example, server 120 previously generated encryption key 132 to encrypt data updates for vehicle 150's throttle control ECU and may now reuse encryption key 132 to encrypt transmission ECU data updates for vehicle 150.

Encryption key 132 of embodiments may be reused to transmit similar types of protected data 130 to vehicle 150. For example, firmware updates for engine system ECUs from a manufacturer may use a first encryption key, while software updates for infotainment system ECUs from the same manufacturer may use a second encryption key. In alternative embodiments, encryption key 132 may be regenerated for each protected data 130 to be transmitted to vehicle 150. In some embodiments, encryption key 132 may be regenerated on a pre-defined time interval based on key size, block size, and/or type of protected data. For example, an encryption key with a 256 bit key size may be regenerated every two months while an encryption key generated using 128 bit key size may be regenerated every year. In another example, encryption key 132 may be regenerated periodically (e.g., daily, weekly, monthly, quarterly, annually, etc.) irrespective of key size, block size, or type of protected data.

After receiving protected data 130 and encryption key 132, server 120 or instructions 126 executing on processor 122 may encrypt protected data 130 with encryption key 132 to produce encrypted protected data 180. In some embodiments, server 120 may have Initially received an encryption key from the content provider of protected data 130 that was used by the content provider to encrypt protected data 130. In such embodiments, the content provider's encryption key and protected data 130 may be encrypted together using encryption key 132 into encrypted protected data 180. In response to encrypting protected data 130 to produce encrypted protected data 180, server 120 or instructions 126 executing on processor 122 may transmit encrypted protected data 180 via data network 140 (e.g., a selected network of one or more data networks 140, 142, and 144) to vehicle 150.

In some embodiments, data network 140 is selected by server 120 based on monitored information related to each data network of one or more data networks 140, 142, and 144 with respect to load and congestion (e.g., amount of network traffic), bandwidth (e.g., transfer speed, channel capacity, channel throughput, etc.), quality of service (e.g., packet loss, bit rate, throughput, transmission delay, availability, jitter, etc.), and geographic access to vehicle 150. For example, vehicle 150 may have geographic access to data networks 140 and 142 but server 120 may identify data network 140 as the selected network because server 120 has determined that transmission charges across data network 140 are lower than the charges for data network 142. In another example, server 120 may identify data network 142 as the selected network for transmitting encrypted protected data 180 because server 120 has determined that transmission delays across data network 142 may be lower than the delays across data network 140. In additional embodiments, server 120 may transmit the information identifying data network 140 as the selected network for transmitting encrypted protected data 180 to vehicle 150 via security network 110 so that vehicle 150 may expect to receive encrypted protected data 180 via the data network 140.

Even if a particular data network of one or more data networks 140, 142, and 144 is geographically accessible to a vehicle of the vehicle fleet, the particular data network may not be selected for transmitting encrypted protected data 180 to the vehicle because the vehicle does not actually have access to the particular data network. For example, data network 140 may be a first cellular network that vehicle 150's owner has a subscription with, data network 142 may be a second cellular network that vehicle 150's owner does not have a subscription with, and data network 144 may be an RF network that does not require a subscription. In this example, vehicle 150 may be communicatively coupled to data networks 140 and 144 via its wireless data network interface (e.g., at least one interface of one or more wireless data network interfaces 250, 260, and 270), but may not be communicatively coupled to data network 142. However, vehicle 152, for example, may have a subscription with data network 142 but not with data network 140, and therefore vehicle 150 may be communicatively coupled to data networks 142 and 144 via its wireless data network interface (e.g., at least one interface of one or more wireless data network interfaces 250, 260, and 270), but not data network 140.

In additional embodiments, a plurality of data networks may be selected and link aggregation methods may be used to provide aggregated downstream capacity across the plurality of data networks to boost delivery of encrypted protected data 180 to vehicle 150. For example, server 120 may use link aggregation methods to transmit encrypted protected data 180 to vehicle 150 via data networks 140 and 144. Link aggregation methods of embodiments may include Link Aggregation Control Protocol (LACP) EtherChannel, Port Aggregation Protocol, Routed Split Multi-Link Trunking, Distributed Split Multi-Link Trunking, other link aggregation protocols, or combinations thereof. In alternative embodiments, none of one or more data networks 140, 142, and 144 may have geographic access to vehicle 150 and server 120 may transmit encrypted protected data 180 to vehicle 150 via security network 110. For example, vehicle 150 may be a boat in the middle of a lake, far from network coverage provided by terrestrial data networks, and only has access to the satellite constellation of security network 110. In this example, server 120 may temporarily transmit encrypted protected data 180 to vehicle 150 via security network 110 until vehicle 150 regains access to one or more data networks 140, 142, and 144.

In some embodiments, server 120 or instructions 126 executing on processor 122 may transmit encrypted protected data 180 to more than one vehicle of the vehicle fleet (e.g., any plurality of vehicles 150, 152, and 154; all vehicles of vehicles 150, 152, and 154). For example, protected data 130 may have been provided by a vehicle manufacturer to improve the functionality of transmission ECUs on a particular vehicle model or on vehicles manufactured in a particular year. In another example, vehicles 150 and 152 may have both been manufactured in a year where their navigation ECU needs a firmware update; in such a situation, server 120 may transmit encrypted protected data 180 (containing the navigation ECU firmware update) by multicast via one or more networks 140, 142, and 144 to vehicles 150 and 152, but not to vehicle 154. In yet another example, vehicles 152 and 154 may be equipped with adaptive cruise control ECUs, but vehicle 150 may not; server 120 may transmit encrypted protected data 180 (containing an adaptive cruise control ECU firmware update) by multicast via one or more networks 140, 142, and 144 to vehicles 152 and 154, but not to vehicle 150. In some embodiments, when a multicast transmission is sent to a plurality of vehicles of the vehicle fleet, encrypted protected data 180 is transmitted via one selected network to each of the plurality of vehicles. For example, encrypted protected data 180 may be transmitted to vehicles 150 and 152 via data network 140 because data network 140 is geographically accessible and has the lowest cost (e.g., data transmission charges, network latency and delay, rerouting processing, etc.) for both vehicles 150 and 152. In additional or alternative embodiments, when a multicast transmission is sent to the plurality of vehicles (e.g., vehicles 150 and 152) of the vehicle fleet, encrypted protected data 180 may he transmitted via different selected networks for each of the plurality of vehicles. For example, encrypted protected data 180 may be transmitted to vehicle 150 via data network 140, but encrypted protected data 180 may instead be transmitted to vehicle 152 via data network 142 because data network 142 has lower costs compared to data network 140 for vehicle 152.

In some embodiments, processing instructions may be transmitted via one or more data networks 140 142, and 144, along with encrypted protected data 180, to vehicle 150. For example, server 120 may transmit encrypted firmware updates for vehicle 150's emissions control ECU, along with processing instructions directing vehicle 150's IVS 200 to install the firmware updates to vehicle 150's emissions control ECU, to vehicle 150 via data network 140. In another example, server 120 may transmit an encrypted video codec for vehicle 150's video system (e.g., an onboard system), along with processing instructions directing vehicle 150's IVS 200 to install the video codec to vehicle 150's video system, to vehicle 150 via data network 140.

One or more data networks 140, 142, and 144 of embodiments used to deliver encrypted protected data 180 to vehicle 150 may include home Wi-Fi networks associated vehicle 150's owner. In additional embodiments, encrypted protected data 180 may be delivered via one or more data networks 140, 142, and 144 to mobile devices associated with vehicle 150's owner to be stored for subsequent transfer via mobile device interfaces to vehicle 150. For example, encrypted protected data 180 may be delivered to and stored on vehicle 150's owner's smartphone and may be later transferred from the smartphone to vehicle 150 via wired (e.g., USB, Lighting, Thunderbolt, etc.) or wireless (e.g., Bluetooth, in-vehicle Wi-Fi, infrared, etc.) communications.

To provide out-of-band security enhancement for encrypted protected data 180 transmitted by server 120 to vehicle 150 via one or more data networked 140, 142, and 144, server 120 or instructions 126 executing on processor 122 may encrypt encryption key 132 using first key 134 of a KEK pair to produce encrypted encryption key 190. First key 134 of embodiments may correspond to second key 226 (e.g., second key 226 of FIG. 2) in vehicle 150's possession that may be used to decrypt encrypted encryption key 190. First key 134 may be retrieved from database 128. In some embodiments, first key 134 may be generated using seed parameters 138 stored in database 128. Seed parameters 136 of embodiments may also be used to regenerate first key 134 on a pre-defined time interval. For example, server 120 and vehicle 150 may have pre-established that first key 134 and second key 226 should be regenerated every two years. In additional embodiments, seed parameters 136 may be recalculated by server 120, and server 120 may regenerate first key 134 using the recalculated seed parameters and transmit the recalculated seed parameters via security network 110 to vehicle 150 to facilitate regenerating second key 226. In alternative embodiments, first key 134 may have been received from vehicle 150 via security network 110. Although embodiments are described herein with reference to possessing, encrypting with, generating, and/or receiving a first key of a KEK pair with respect to a select vehicle, it should be appreciated that the concepts herein may be likewise used to possess, encrypt with, generate, and/or receive a first key of a KEK pair with respect to a plurality of vehicles or even all vehicles in a fleet.

In some embodiments, first key 134 and its corresponding second key 226 may be asymmetric KEK pairs. In operation according to embodiments, first key 134 is a public key and its corresponding second key 226 is a private key in the possession of vehicle 150. Data of embodiments encrypted with a public key may only be decrypted with its corresponding private key. In additional embodiments, first key 134 may have been stored in database 128 and its corresponding second key 226 may have been stored in database 224 by vehicle 150's manufacturer or a designated proxy. In alternative embodiments, first key 134 and corresponding second key 226 may have been generated by server 120 using seed parameters 136 in database 128, and second key 226 may have been transmitted to vehicle 150 via security network 110. For example, server 120 may generate a unique public key (e.g., first key 134) and a unique private key (e.g., second key 226) associated with vehicle 150 using seed parameters 136 stored in database 128, and server 120 may transmit second key 226 to vehicle 150 via security network 110 for use in future security sessions. In some embodiments, first key 134 and second key 226 may be regenerated based on a pre-defined condition. For example, server 120 may regenerate first key 134 and second key 226 using seed parameters 136 when title to vehicle 150 is transferred from one owner to another. When the asymmetric KEK pair associated with vehicle 150 is regenerated according to embodiments, server 120 may, for example, encrypt the replacement second key with an old first key (e.g., the previous public key associated with vehicle 150), transmit the encrypted replacement second key to vehicle 150, and replace the old first key with the replacement first key as first key 134. Once the IVS 200 of vehicle 150 receives and decrypts the encrypted replacement second key using an old second key (e.g., the previous private key associated with vehicle 150), vehicle 150 may replace the old second key with the replacement second key as second key 226. Asymmetric KEK pairs of embodiments provide an additional tier of encryption to enhance the security of in-band vehicle data communications via one or more data networks. Even if a malicious actor were to compromise one or more data networks 140, 142, and 144 and security network 110 and obtain access to encrypted protected data 180 and encrypted encryption key 190, the malicious actor may not be able to decrypt encrypted encryption key 190, and in turn encrypted protected data 180, without vehicle 150's second key 226. Such a two-tier encryption method involving an encryption key that is further encrypted using a public and private KEK pair provides improved security for communicating secured data to a vehicle.

In alternative embodiments, first key 134 and its corresponding second key 226 may be symmetric KEK pairs. First key 134 and second key 226 of embodiments may be independently generated by server 120 and vehicle 150 using shared seed parameters 136 and 228 containing common information. In some embodiments, shared seed parameters 136 and 228 may be a common secret established when vehicle 150 was manufactured, and shared seed parameters 136 and 228 were stored in database 224 of vehicle 150's IVS 200 and provided to server 120 for storage in database 128 by vehicle 150's manufacturer. In alternative embodiments, shared seed parameters 136 and 228 may be calculated by server 120 and delivered to vehicle 150 over security network 110. In additional embodiments, seed parameters 136 may be recalculated by server 120, and seed parameters 136 and seed parameters 228 may no longer share a common secret. In such a situation, server 120 may, for example, encrypt seed parameters 136 (e.g., the recalculated seed parameters) with an old first key (e.g., derived from the old shared seed parameters), transmit the encrypted seed parameters 136 to vehicle 150, and derive a replacement first key from seed parameters 136 to replace the old first key as first key 134. Once the IVS 200 of vehicle 150 receives and decrypts the encrypted seed parameters 136 using an old second key (e.g., derived from the old shared seed parameters), vehicle 150 may replace the old shared seed parameters with seed parameters 136 as seed parameters 228 (e.g., reestablishing the shared secret) and use seed parameters 228 to derive a replacement second key to replace the old second key as second key 226. In some embodiments, symmetric KEK pairs may be used to provide cryptography for real-time communications. Symmetric KEK pairs of embodiments may be preferred over asymmetric KEK pairs, which may be more computationally complex, for real-time communications. Symmetric KEK, pairs of embodiments provide an additional tier of encryption to enhance the security of in-band vehicle data communications via one or more data networks. Even if a malicious actor were to compromise one or more data networks 140, 142, and 144 and security network 110 and obtain access to encrypted protected data 180 and encrypted encryption key 190, the malicious actor may not be able to decrypt encrypted encryption key 190, and in turn encrypted protected data 180, without either server 120's first key 134 or vehicle 150's second key 226. Such a two-tier encryption method involving an encryption key that is further encrypted using a symmetric KEK pair provides improved security for communicating secured data to a vehicle.

In response to encrypting encryption key 132 using first key 134, server 120 or instructions 126 executing on processor 122 may transmit encrypted encryption key 190 via security network 110 directly to vehicle 150. Vehicle 150 may be communicatively coupled to security network 110 via wireless security network interface 240 of IVS 200. Security communications (e.g., encrypted encryption key 190, seed parameters 136, etc.) received from security network 110 via wireless security network interface 240 may be transferred to processor 210 for performing security operations (e.g., decrypting encrypted encryption key 190, decrypting encrypted protected data 180, generating second key 226, etc.). Security network 110 of embodiments preferably provides broader geographic coverage than any individual data network of one or more data networks 140, 142, and 144. For example, vehicle 150 may initially be in a geographic area with access to security network 110 and data networks 140 and 142 but not data network 144. Vehicle 150 may later travel to a different geographic area and lose access to data networks 140 and 142, gain access to data network 144, and maintain access with security network 110. In some embodiments, security network 110 may provide near-ubiquitous access to the vehicle fleet. For example, vehicle 150 may have access to security network 110 and one or more data networks 140, 142, and 144 at one geographic area and may continue to have access to security network 110 even when it loses access to any or all of one or more data networks 140, 142, and 144 at a different geographic area (e.g., rural areas, unpopulated areas, bodies of water, mountain ranges, etc.). In operation according to embodiments, security network 110 may receive encrypted encryption key 190 from server 120 and directly deliver encrypted encryption key 190 to vehicle 150 to facilitate decrypting encrypted protected data 180 that was or is to be delivered to vehicle 150 via one or more data networks 140, 142, and 144. For example, encrypted encryption key 190, sent by server 120 to vehicle 150, may traverse security network 110 and may not travel across one or more data networks 140, 142, and 144.

In some embodiments, encrypted encryption key 190 is transmitted directly to vehicle 150 whenever encrypted protected data 180 is transmitted to vehicle 150 via one or more data networks 140, 142, and 144. In alternative embodiments, encrypted encryption key 190 may not be transmitted to vehicle 150 along with encrypted protected data 180 because encrypted encryption key 190 was transmitted to vehicle 150 in a previous security session. For example, vehicle 150 may have received encrypted encryption key 190, decrypted encrypted encryption key 190 into encryption key 132, and stored encryption key 132 in database 224 as encryption key 227 during a prior transmission from server 120 and may reuse encryption key 227 to decrypt future encrypted protected data that vehicle 150 receives from server 120. According to embodiments, transmitting encrypted encryption key 190 via security network 110, an out-of-band network to one or more data networks 140, 142, and 144, may enhance the security of encrypted transmissions via the in-band data networks (e.g., one or more data networks 140, 142, and 144) by making it technically difficult or impossible for a malicious actor to penetrate the security of the combined encrypted transmissions to vehicle 150. For example, any malicious actor attempting to intercept transmissions across one or more data networks 140, 142, and 144 would need to have knowledge that encrypted protected data 180 may only be decrypted using a security handshake process taking place via an out-of-band network (e.g., security network 110). Also, the malicious actor may need specialized wireless interfaces (e.g., IVS 200 containing wireless network security interface 240 and one or more wireless data network interfaces 250, 260, and 270) uniquely configured to communication with security network 110 in order to intercept communications across both one or more data networks 140, 142, and 144 and security network 110.

In response to server 120 or instructions 126 executing on processor 122 transmitting transmit encrypted protected data 180 via data network 140 (e.g., a selected network of one or more data networks 140, 142, and 144) to vehicle 150 and encrypted encryption key 190 via security network 110 directly to vehicle 150, vehicle 150 may use second key 226 to decrypt encrypted encryption key 190 into encryption key 227 and, in turn, use encryption key 227 to decrypt encrypted protected data 180 into protected data 132. In some embodiments, vehicle 150 may receive encrypted protected data 180 via data network 140 but may not receive encrypted encryption key 190 via security network 110 because encrypted protected data 180 may be decrypted using an encryption key received in a previous security session. For example, during a first security session, server 120 may have sent encrypted firmware updates (e.g., encrypted protected data 180) for vehicle 150's throttle control ECU along with encrypted encryption key 190. Vehicle 150 may store encrypted key 227 (e.g., decrypted from encrypted encryption key 190 using second key 226) in database 224. During a second security session, server 120 may send encrypted firmware updates (e.g., encrypted protected data 180) for vehicle 150's emissions control ECU without sending an encryption key. In this example, vehicle 150 may reuse encrypted key 227 stored in database 224 to decrypt the emissions control firmware updates. In this manner, encryption key 227 of embodiments stored in database 224 may be reused to decrypt subsequently received encrypted protected data 180 from server 120. In additional embodiments, encryption key 227 may be replaced when it no longer corresponds to encryption key 132 stored in memory 124 of server 120. For example, server 120 may have regenerated encryption key 132 and vehicle 150 may receive and decrypt encrypted encryption key 190 and determine that encryption key 132 no longer matches encryption key 227. In this example, the newly received encryption key 132 is stored in database 224 and overwrites vehicle 150's previous encryption key to become encryption key 227.

In some embodiments, server 120 may receive communications from vehicle 150 via one or more data networks 140, 142, and 144. In alternative embodiments, server 120 may receive communications from vehicle 150 via security network 110. Communications from vehicles 150 to server 120 via security network 110 may be encrypted using an asymmetric KEK pair associated with server 120; server 120's private key of the KEK pair associated with server 120 may be stored in database 128 and server 120's public key may be stored in database 224 of vehicle 150's IVS 200 and may be used by vehicle 150 to encrypt vehicle communications to server 120. Communications from vehicle 150 of embodiments may include accident emergency notification, global emergency communications, security notifications, vehicle recovery notifications, on-board diagnostics (OBD) code reporting, other vehicle status notifications, or combinations thereof. For example, after vehicle 150 is involved in a collision, server 120 may receive an emergency 911 call from vehicle 150's IVS 200. In another example, server 120 may receive continuous OBD code reporting for usage-based insurance calculations and vehicle health monitoring. In another example, vehicle 150's owner may report that vehicle 150 has been stolen and server 120 may receive vehicle recovery notifications to assist vehicle 150's owner in recovering vehicle 150. In additional embodiments, server 120 may receive feedback from vehicle 150 regarding vehicle 150's location, vehicle 150's accessibility (e.g., network connectivity, network latency, dropped transmissions, etc.) to one or more data networks 140, 142, and 144, or transmission status (e.g., transmissions received, transmission corrupted, etc.) of prior communications. For example, information about what data networks of one or more data networks 140, 142, and 144 that vehicle 150 has access to and the performance (e.g., load and congestion, bandwidth, and/or quality of service) of those networks may allow server 120 to balance transmission loads to the vehicle fleet in general, and vehicle 150 specifically, across one or more data networks 140, 142, and 144.

In alternative embodiments, server 120 may receive specific data requests from vehicle 150 to be executed, played, or displayed on an onboard system (e.g., audio systems, video systems, web browsing systems, etc.). For example, vehicle 150 may request that server 120 provide protected data 130 comprising a DRM-protected video file, a DRM-protected audio file, a streamed satellite radio program, a website, any other multimedia content, and/or combinations thereof. For example, vehicle 150 may send a request for a DRM-protected movie to server 120 via one or more of the data networks 140, 142, and 144. In response to vehicle 150's request, server 120 may send the DRM-protected movie (e.g., protected data 180) to vehicle 150 for use by vehicle 150's video system ECU via one or more data networks 140, 142, and 144 and send DRM decryption parameters to facilitate decrypting the DRM-protected movie to vehicle 150 via security network 110. In another example, server 120 may receive a request from vehicle 150 for an internet website to be displayed on an in-vehicle web browser, and server 120 will retrieve protected data 130 (e.g., the requested website) for transmission to vehicle 150 via one or more data networks 140, 142, and 144.

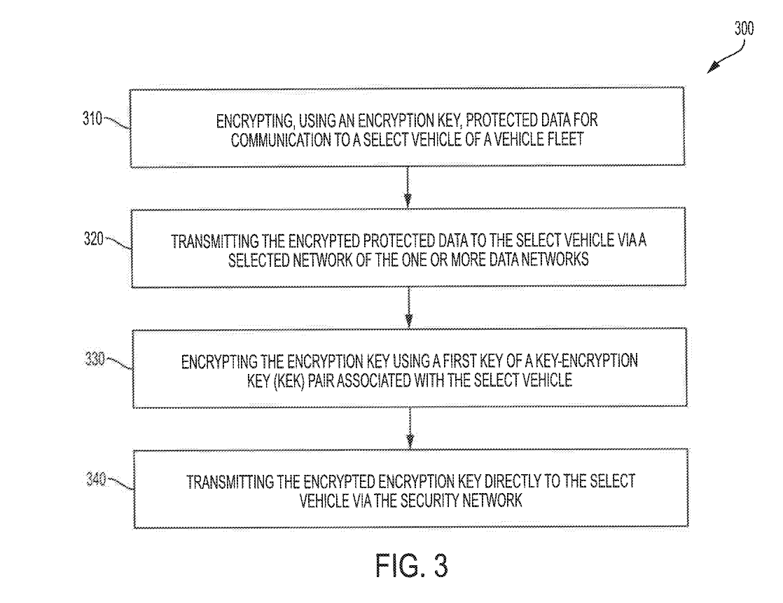

Referring to FIG. 3, a flow diagram of an embodiment of a method for using cryptographic communications via an out-of-band side-channel security network to provide security enhancement to vehicle data in-band communications via one or more data networks is shown as method 300. In an embodiment, method 300 may be performed by a server (e.g., the server 120 of FIG. 1). For example, instructions 126 may include instructions that, when executed by processor 122 of FIG. 1, cause processor 122 to perform the operations of method 300. Although embodiments are described below with to a select vehicle of a vehicle fleet, it should be appreciated that the concepts herein may likewise apply to a plurality of vehicles or even all vehicles in the fleet.

At 310, method 300 includes encrypting, using an encryption key, protected data for communication to a select vehicle of a vehicle fleet. In an embodiment, encrypting the protected data (e.g. protected data 130 of FIG. 1) with the encryption key (e.g. encryption key 132 of FIG. 1) may produce an encrypted protected data (e.g. encrypted protected data 180 of FIG. 1). Encrypted protected data of embodiments may be decrypted, using the encryption key, to obtain the protected data. In some embodiments, the protected data contains data (e.g., software, firmware, or other control instructions) updates for the select vehicle's (e.g., select vehicle 150 of FIG. 1) automotive ECUs. In additional embodiments, the protected data contains DRM-protected audio files, DRM-protected video files, or any other form of data content that requires protection to prevent unauthorized use or modification, or combinations thereof.

The encryption key of embodiments may be generated by the server. In some embodiments, the encryption key may be reused from a previous security session. For example, the encryption key may have been initially generated to encrypt a first protected data to send to the select vehicle, but may now be reused to encrypt a second protected data to send to the select vehicle. In additional embodiments, different encryption keys may be used for different types of protected data. For example, if the protected data contains data updates for the select vehicle's throttle control ECU, the encryption key may have a key size of 256 bits. In an additional example, if the protected data contains data updates for the select vehicle's navigation ECU, the encryption key may have a key size of 128 bits. In some embodiments, the encryption key may be regenerated on a pre-defined time interval based on key size, block size, and/or type of protected data. For example, if encryption key with a 256 bit key size may be regenerated every two months while encryption key generated using 128 bit key size may be regenerated every year. In another example, the encryption key may be regenerated periodically (e.g., daily, weekly, monthly, quarterly, annually, etc.) irrespective of key size, block size, or type of protected data.

At 320, method 300 includes transmitting the encrypted protected data to the select vehicle via a selected network of the one or more data networks. In an embodiment, the selected data network (e.g., network 140 of one or more data networks 140, 142, and 144 of FIG. 1) may be chosen based on bandwidth (e.g., transfer speed, channel capacity, channel throughput, etc.), cost (e.g., data transmission charges, network latency and delay, rerouting processing, etc.), and geographic access to the select vehicle. In some embodiments, more than one data network may be selected and bandwidth across the selected data networks may be aggregated together to boost delivery of the encrypted protected data to the select vehicle. In alternative embodiments, none of the one or more data networks may have geographic access to the select vehicle and the encrypted protected data may be transmitted to the select vehicle via a security network (e.g., the security network of FIG. 1).

In some embodiments, the encrypted protected data may be transmitted to more vehicles of the vehicle fleet than just the select vehicle. For example, the protected data may have been provided by a vehicle manufacturer to improve the functionality of transmission ECUs on a particular vehicle model or vehicles manufactured in a particular year. In such situations, the encrypted protected data may be transmitted by multicast via the one or more data networks to a plurality of vehicles (e.g., vehicles 150 and 152 of FIG. 1) of the vehicle fleet that correspond to the particular vehicle model or year of manufacture. In some embodiments, when a multicast transmission is sent to the plurality of vehicles of the vehicle fleet, the encrypted protected data may be transmitted via different selected networks for each of the plurality of vehicles. For example, encrypted protected data 180 may be transmitted to vehicle 150 via data network 140, but encrypted protected data 180 may instead be transmitted to vehicle 152, which may also have geographic access to data network 140, via data network 142 because data network 142 has lower costs for vehicle 152. In alternative embodiments, when a multicast transmission is sent to the plurality of vehicles, the encrypted protected data may be transmitted via one selected network. For example, encrypted protected data 180 may be transmitted to vehicles 150 and 152 via data network 140 because data network 140 is both geographically accessible and has the lowest cost.

In some embodiments, processing instructions may be transmitted via the selected data network along with the encrypted protected data to the select vehicle. For example, encrypted data (e.g., software, firmware, or other control instructions) updates for the select vehicle's emissions control ECU and processing instructions directing the select vehicle's IVS (e.g., IVS 200 of vehicle 150 of FIGS. 1 and 2) to install the data updates to the select vehicle's emissions control ECU may be transmitted over the selected data network to the select vehicle.

At 330, method 300 includes encrypting the encryption key using a first key of a key-encryption key (KEK) pair associated with the select vehicle. In an embodiment, encrypting the encryption key with the first key (e.g., first key 134 of FIG. 1) may produce an encrypted encryption key (e.g., encrypted encryption key 190 of FIG. 1), as described with reference to the operations of system 100 of FIG. 1. The first key of embodiments may correspond to a second key (e.g., second key 226 of IVS 200 of vehicle 150 of FIG. 2) in the select vehicle's possession that may be used to decrypt the encrypted encryption key. In some embodiments, the first key and its corresponding second key may be asymmetric keys of the KEK pair. In such embodiments, the first key is a public key and its corresponding second key is a private key. Data of embodiments encrypted with a public key may only be decrypted with its corresponding private key. In some embodiments, the first key and its corresponding second key may have been generated by the server using seed parameters (e.g., seed parameters 136 of database 128 of server 120 of FIG, 1) and the second key may have been transmitted to the select vehicle via the security network. For example, the second key transmitted to the select vehicle may be a private key generated by the server that corresponds to the first key in the server's possession (a public key generated by the server). In additional embodiments, the first key and its corresponding second key may have been provided by the select vehicle's manufacturer.

In alternative embodiments, the first key and its corresponding second key may be symmetric KEK pairs. The symmetric first key and its corresponding symmetric second key may be independently generated based on shared seed parameters containing common information. In some embodiments, the shared seed parameters may be a common secret established when the select vehicle was manufactured. In additional embodiments, the shared seed parameters may be transmitted to the select vehicle over the security network to facilitate generation of the second key by the select vehicle.

At 340, method 300 includes transmitting the encrypted encryption key directly to the select vehicle via the security network. In an embodiment, the encrypted encryption key is transmitted directly to the select vehicle via the security network, without traversing any of the one or more data networks. In some embodiments, the encrypted encryption key may be transmitted directly to the select vehicle whenever the encrypted protected data is transmitted to the select vehicle via the one or more data networks. In additional embodiments, the encrypted encryption key may not be transmitted to the select vehicle along with the encrypted protected data because the encrypted encryption key may have been transmitted to the select vehicle in a previous security session and may already be stored in a database (e.g., database 224 of IVS 200 of vehicle 150 of FIG. 2) associated with the select vehicle. For example, the encrypted encryption key may have been previously transmitted to the select vehicle accompanying encrypted firmware updates for the select vehicle's throttle control ECU and does not need to be retransmitted with a subsequent encrypted firmware update for the select vehicle's emissions control ECU that is encrypted with the same encryption key.

Method 300 provides an improved technique for securely communicating vehicle data to a select vehicle of a vehicle fleet by using cryptographic communications via an out-of-band side-channel security network to provide security enhancement with respect to in-band vehicle data communications via one or more data networks. This allows method 200 to enhance the security of the in-band data networks by making it technically difficult or impossible for a malicious actor to penetrate the security of the combined encrypted transmissions via the one or more data networks and the security network. For example, any malicious actor intercepting transmissions across the one or more data networks would need to have knowledge that the encrypted protected data may only be decrypted using a security handshake process taking place via the out-of-band security network. Also, the malicious actor may lack the specialized wireless interfaces to intercept communications across both the one or more data networks and the security network. Further, by introducing an additional tier of encryption for the encryption parameters that are delivered via the security network, method 300 may prevent malicious intrusion into the overall data delivery network. For example, even if a malicious actor where to compromise the one or more data networks and the security network and obtain access to the encrypted protected data and the encrypted encryption key, the malicious actor would be unable to decrypt the encrypted encryption key, and in turn the encrypted protected data, without the second key possessed by the select vehicle. Such a two-tier encryption method involving an encryption key that is further encrypted using a KEK pair provides improved security for communicating secured data to a vehicle. Thus, method 300 may improve the security and functionality of computing devices (e.g., automotive electronics and vehicles as a whole) and environments (e.g., security of the delivery networks for automotive data).

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A method for secure communication of protected data to a select vehicle of a vehicle fleet comprising:
encrypting, by a processor using an encryption key, protected data for communication to the select vehicle of the vehicle fleet, wherein the protected data is configured to update one or more automotive control systems of the select vehicle; and wherein the encryption key is configured to encrypt the protected data and decrypt the encrypted protected data;
transmitting, by the processor, the encrypted protected data to the select vehicle via a selected network of one or more data networks, wherein the one or more data networks comprise at least one internet protocol network, wherein the selected network is chosen based on bandwidth and geographic access to the select vehicle, wherein each of the one or more data networks provide narrower geographic access to the select vehicle than a security network, wherein the one or more data networks exclude the security network; wherein the security network comprises a satellite constellation and is configured as an out-of-band side-channel to provide security enhancement to the one or more data networks; wherein the select vehicle comprises two or more wireless communication interfaces; and wherein a first interface of the two or more wireless communication interfaces is configured to communicate with the security network and a second interface of the two or more wireless communication interfaces is configured to communicate with the one or more data networks;
encrypting, by the processor, the encryption key using a first key of a key-encryption key (KEK) pair associated with the select vehicle, wherein the encrypted encryption key is configured to be decrypted by a second key of the KEK pair possessed by the select vehicle; and
transmitting, by the processor, the encrypted encryption key directly to the select vehicle via the security network.

2. The method of claim 1, wherein the one or more data networks comprises an LTE network, an ATSC network, a Wi-Fi network, an Ethernet network, a Ku band satellite communications network, a Ka band satellite communications network, or any combination thereof.

3. The method of claim 1, wherein the KEK pair is unique to each vehicle of the vehicle fleet.

4. The method of claim 1, wherein the first key of the KEK pair comprises a public encryption key unrestricted to the processor and the select vehicle of the vehicle fleet, and wherein the second key of the KEK pair comprises a private encryption key exclusive to the processor and the select vehicle.

5. The method of claim 4, further comprising:
generating, by the processor, a replacement KEK pair comprising:
a third key comprising a public encryption key unrestricted to the processor and the select vehicle of the vehicle fleet, and
a fourth key comprising a private encryption key exclusive to the processor and the select vehicle;
encrypting, by the processor, the fourth key of the replacement KEK pair using the first key of the KEK pair, wherein the encrypted fourth key is configured to be decrypted by the second key of the KEK pair;
transmitting, by the processor, the encrypted fourth key directly to the select vehicle of the vehicle fleet via the security network, wherein the fourth key is configured to replace the second key; and
replacing, by the processor, the first key with the third key of the replacement KEK pair for subsequent encryption of the encryption key for transmissions via the security network, wherein the fourth key is further configured to decrypt the encryption key encrypted by the third key.

6. The method of claim 1, wherein the first key of the KEK pair and second key of the KEK pair are symmetric keys generated independently by the processor and the select vehicle of the vehicle fleet based on pre-established seed parameters.

7. The method of claim 6, wherein the first key of the KEK pair is regenerated independently by the processor on a pre-determined interval, and wherein the second key of the KEK pair is regenerated independently by the select vehicle of the vehicle fleet on the pre-determined interval.

8. The method of claim 6, further comprising:
generating, by the processor, new seed parameters, wherein the new seed parameters are configured to replace the pre-established seed parameters and trigger, upon receipt by the select vehicle of the vehicle fleet, regeneration of the second key of the KEK pair;
encrypting, by the processor, the new seed parameters using the first key of the KEK pair, wherein the encrypted new seed parameters are configured to be decrypted by the second key of the KEK pair;
transmitting, by the processor, the encrypted new seed parameters directly to the select vehicle via the security network;
regenerating, by the processor using the new seed parameters, the first key of the KEK pair.

9. The method of claim 1, wherein transmitting the encrypted data to the select vehicle via the selected network of the data network and transmitting the encrypted encryption key directly to the select vehicle via the security network occur in parallel.

10. The method of claim 1, further comprising:
encrypting, by the processor using the encryption key, new protected data for communication to the select vehicle of the vehicle fleet;
transmitting, by the processor, the encrypted new protected data to the select vehicle via the selected network of the one or more data networks, wherein the encrypted new protected data is configured to be decrypted by the encryption key transmitted to the select vehicle in a prior transmission.

11. The method of claim 1, further comprising:
generating, by the processor, the encryption key based on a dataset of a plurality of datasets and on a pre-determined interval, wherein each of the plurality of datasets comprise a different amount of information and correspond to a control system of the one or more automotive control systems of the select vehicle, wherein the pre-determined interval is greater when the dataset comprises more information and lower when the dataset comprises less information.

12. The method of claim 1, further comprising:
transmitting, by the processor, the encrypted protected data to a plurality of vehicles of the vehicle fleet via the one or more data networks; and
transmitting, by the processor, the encrypted encryption key directly to the plurality of vehicles via the security network.

13. A computer-readable storage medium storing instructions that, when executed by a processor, cause the processor to perform operations for secure communication of protected data to a select vehicle of a vehicle fleet comprising:
encrypting, using an encryption key, protected data for communication to the select vehicle of the vehicle fleet, wherein the protected data is configured to update one or more automotive control systems of the select vehicle; and wherein the encryption key is configured to encrypt the protected data and decrypt the encrypted protected data;
transmitting the encrypted protected data to the select vehicle via a selected network of one or more data networks, wherein the one or more data networks comprise at least one internet protocol network, wherein the selected network is chosen based on bandwidth and geographic access to the select vehicle, wherein each of the one or more data networks provide narrower geographic access to the select vehicle than a security network, wherein the one or more data networks exclude the security network; wherein the security network comprises a satellite constellation and is configured as an out-of-band side-channel to provide security enhancement to the one or more data networks; wherein the select vehicle comprises two or more wireless communication interfaces; and wherein a first interface of the two or more wireless communication interfaces is configured to communicate with the security network and a second interface of the two or more wireless communication interfaces is configured to communicate with the one or more data networks;
encrypting the encryption key using a first key of a key-encryption key (KEK) pair associated with the select vehicle, wherein the encrypted encryption key is configured to be decrypted by a second key of the KEK pair possessed by the select vehicle; and
transmitting the encrypted encryption key directly to the select vehicle via the security network.

14. The computer-readable storage medium of claim 13, wherein the first key of the KEK pair comprises a public encryption key unrestricted to the processor and the select vehicle of the vehicle fleet, and wherein the second key of the KEK pair comprises a private encryption key exclusive to the processor and the select vehicle.

15. The computer-readable storage medium of claim 13, wherein the first key of the KEK pair and second key of the KEK pair are symmetric keys generated independently by the processor and the select vehicle of the vehicle fleet based on pre-established seed parameters.

16. The computer-readable storage medium of claim 13, further storing instructions that, when executed by a processor, cause the processor to perform operations comprising:
generating the encryption key based on a dataset of a plurality of datasets and on a pre-determined interval, wherein each of the plurality of datasets comprise a different amount of information and correspond to a control system of the one or more automotive control systems of the select vehicle, wherein the pre-determined interval is greater when the dataset comprises more information and lower when the dataset comprises less information.

17. An apparatus comprising:
at least one processor configured to perform operations for secure communication of protected data to a select vehicle of a vehicle fleet comprising:
encrypt, using an encryption key, protected data for communication to the select vehicle of the vehicle fleet, wherein the protected data is configured to update one or more automotive control systems of the select vehicle; and wherein the encryption key is configured to encrypt the protected data and decrypt the encrypted protected data;
transmit the encrypted protected data to the select vehicle via a selected network of one or more data networks, wherein the one or more data networks comprise at least one internet protocol network, wherein the selected network is chosen based on bandwidth and geographic access to the select vehicle, wherein each of the one or more data networks provide narrower geographic access to the select vehicle than a security network, wherein the one or more data networks exclude the security network; wherein the security network comprises a satellite constellation and is configured as an out-of-band side-channel to provide security enhancement to the one or more data networks; wherein the select vehicle comprises two or more wireless communication interfaces; and wherein a first interface of the two or more wireless communication interfaces is configured to communicate with the security network and a second interface of the two or more wireless communication interfaces is configured to communicate with the one or more data networks;
encrypt the encryption key using a first key of a key-encryption key (KEK) pair associated with the select vehicle, wherein the encrypted encryption key is configured to be decrypted by a second key of the KEK pair possessed by the select vehicle; and
transmit the encrypted encryption key directly to the select vehicle via the security network; and
a memory coupled to the at least one processor.

18. The apparatus of claim 17, wherein the first key of the KEK pair comprises a public encryption key unrestricted to the processor and the select vehicle of the vehicle fleet, and wherein the second key of the KEK pair comprises a private encryption key exclusive to the processor and the select vehicle.

19. The apparatus of claim 17, wherein the first key of the KEK pair and second key of the KEK pair are symmetric keys generated independently by the processor and the select vehicle of the vehicle fleet based on pre-established seed parameters.

20. The apparatus of claim 17, wherein the at least one processor is further configured to:
generate the encryption key based on a dataset of a plurality of datasets and on a pre-determined interval, wherein each of the plurality of datasets comprise a different amount of information and correspond to a control system of the one or more automotive control systems of the select vehicle, wherein the pre-determined interval is greater when the dataset comprises more information and lower when the dataset comprises less information.
